(19) United States
(12) Patent Application Publication
(10) Pub. No.: US 2015/0081590 A1
(43) Pub. Date: Mar. 19, 2015

(54) SYSTEM AND METHOD FOR ANALYZING THE PERFORMANCE OF MORTGAGE-BACKED SECURITIES AND IDENTIFYING POTENTIAL MORTGAGE BORROWERS

(71) Applicant: David Avrick, Santa Barbara, CA (US)

(72) Inventor: David Avrick, Santa Barbara, CA (US)

(21) Appl. No.: 14/025,972

(22) Filed: Sep. 13, 2013

(51) Int. Cl. G06Q 40/06

(52) U.S. Cl. CPC G06Q 40/06
USPC 705/36 R

(57) ABSTRACT

A method for analyzing and forecasting the performance of a mortgage-backed security or pool thereof comprises the steps of collecting actual data relating to mortgage loan transactions and property valuations, determining whether the property value for a particular real property is above or below a current mortgage balance, and associating a performance rating to the real property based on such determination. A method for identifying potential mortgage borrowers comprises the steps of collecting actual data relating to client information and real estate listings, determining whether a client listed therein may be in need of a new mortgage loan, and notifying one or more third-parties of such determination. A system for running the aforementioned methods comprises a computer readable medium, an input means, a processor, and a display module, which system is capable of executing various subroutines and user commands to perform the methods.

### CROSS-REFERENCE TO RELATED APPLICATIONS

None.

### FIELD OF THE DISCLOSURE

The present disclosure relates to a system and method for analyzing mortgage-backed securities and identifying potential borrowers, and, more particularly, to a system and method for analyzing and forecasting the performance of a mortgage-backed security or pool thereof and for identifying potential mortgage borrowers.

### BACKGROUND

Mortgage-backed securities are bonds that have been bundled together for investment purposes, which bonds pertain to mortgages over real property. Mortgage-backed securities may be commercial or residential and thus may be backed by either commercial or residential real estate. Generally, financial institutions may group a pool of mortgage loans together into one or more securities and may thereafter sell off portions thereof to investors who will carry the investment(s) thereon until either the mortgage loan transaction is closed (through the satisfaction thereof or otherwise) or they sell the investment(s) to other investors or institutions.

The performance of specific mortgage-backed securities depends largely on the fulfillment of payment obligations by the borrower. As such, if the borrower pays off his or her loan balance on time and does not default, the investor maintaining a security over his or her loan may enjoy a financial gain. In particular, investors derive their investment profits from the scheduled payments on a loan's principal and interest balances as well as any prepayments made to the principal balance. Contrastingly, if the borrower fails to pay or his or her loan balance on time and thereby defaults on the loan, the investor may face a financial loss. For example, if the loan is defaulted upon and the respective real property is subsequently foreclosed upon, the investor may lose a portion or all of his or her investment in the security over that real property.

Because investing in mortgage-backed securities requires putting up a financial stake, which usually is significant, it is important that investors be made aware of their investments' performances at all times. If a security is performing poorly, investors should be notified of such so that they may choose to sell off or otherwise limit their investment thereon to prevent themselves from losing money. Similarly, if a security is performing well, investors should be notified so that they may choose to invest in that security or otherwise maintain their investment thereon. As such, it is very important that investors receive timely updates as to the performance of their various mortgage-backed security investments.

However, existing solutions in the field merely rely on financial estimates and approximations in order to evaluate the performance of a particular security or pool thereof. These solutions often use developed algorithms to map out projections for each investment based in part on past performance and the real estate market as a whole. Unfortunately though, because these projections are based largely on estimates and approximations, there is a potential margin of error on each performance projection, which margin of error may be substantial. As a result, investors cannot be made sufficiently aware of the accurate performance or financial status of their securitized investments until a retrospective report is compiled from such past performance.

The fact remains that investors must be aware of the performance of these securities in order to make informed decisions as to whether to maintain or sell the investments, or whether to invest in a new security at all. Thus, existing solutions fail to provide investors with enough information to determine with a sufficient degree of confidence how mortgage-backed securities are performing, and, specifically, to determine and provide the potential profit and potential deficit associated with investing or maintaining an investment in a mortgage-backed security or a pool thereof. The present inability in the field to determine accurately calculated performance values means that investors cannot make fully informed decisions on mortgage-backed security investments, and therefore that their risk of losing their investment stake is higher than it needs to be.

Further, and as is apparent, the greater the number of mortgage-backed securities there are, the greater the number of investment opportunities there will be. Accordingly, it is important that potential mortgage borrowers be identified by financial lending institutions so that more securities may be compiled, which in turn facilitates the ability of investors to invest more in such securities. Many mortgage borrowers decide to enter into mortgage loan transactions independent of outside sources; however, the number of potential borrowers would be increased through the targeted advertising of mortgage loan opportunities to individuals who and entities that either remain undecided on whether or not to enter into such a loan transaction or have not considered the prospect at all. Such targeted advertising may have the effect of causing potential borrowers to decide to enter into mortgage loan transactions.

Consequently, there exists a need for a system and method that uses actual valuation, mortgage, listing, and client data to determine the potential profit and potential deficit associated with investing in a mortgage-backed security or pool thereof at any given time and to identify potential mortgage borrowers for entering into new mortgage loan transactions.

### SUMMARY OF THE INVENTION

In view of the foregoing disadvantages of the prior art, a system and method for analyzing and forecasting the performance of a mortgage-backed security or pool thereof and for identifying potential mortgage borrowers configured to include all the advantages of the prior art and to overcome the drawbacks inherent therein is provided. It is an object of the present disclosure to provide a system and method that uses accurate data to determine whether investing or maintaining an investment in a mortgage-backed security or pool thereof would be profitable and to determine whether a client may be in need of a new mortgage loan, which accurate data may be updated at any time in order to evaluate investment performance and borrower identification using current information.

The system and method involve collecting actual data relating to mortgage loan transactions and real property valuations, comparing that data to determine whether the property value for a particular real property listed for sale is greater than or less than a current mortgage balance, and associating a performance rating to the real property based on the results of such comparison. This performance rating will indicate the investment potential for a security on that property's mortgage, and, specifically, whether investing in such a security or maintaining an investment thereon would result in a profit or a deficit for the investor. The system and method further involve collecting client data and comparing that data to real estate listing data to determine whether a client listed therein needs or may soon need a new mortgage loan or may otherwise be purchasing or financing a new real property.

In an embodiment, a method for analyzing and forecasting the performance of a mortgage-backed security or pool thereof comprises the steps of receiving valuation data for the at least one real property, obtaining mortgage data for at least one real property, storing the mortgage data and valuation data in at least one database, comparing the mortgage data and valuation data to determine a financial status for the at least one real property, and associating a performance rating with the at least one real property based on the financial status thereof. The mortgage data may include at least one of an original loan amount, a purchase amount, an execution date, an interest rate, and a loan term. The valuation data may include at least one of a listing price, a fair market valuation, an appraisal amount, and a real estate comparison valuation. Comparing the mortgage data and the valuation data comprises the steps of extrapolating a mortgage balance using the mortgage data, retrieving a property value from the valuation data, and determining whether the property value is greater or less than the mortgage balance. The method further allows a user to repeat any of the steps to reflect updated data.

In a further embodiment, the financial status of the at least one real property is a short sale where the property value is lower than the mortgage balance and is a prepayment where the property value is higher than the mortgage balance, and the performance rating indicates a potential profit where the financial status is a prepayment and is a potential deficit where the financial status is a short sale.

In a further embodiment, the method may comprise the step of notifying a lender of a mortgage on the at least one real property where the financial status thereof is a short sale.

In an embodiment, a method for identifying potential mortgage borrowers comprises the steps of receiving listing data that may include at least one listing address, obtaining client data that may include at least one client name and/or client address, storing the client data and listing data in at least one database, and comparing the client data and listing data to determine whether a client listed in the client data may be in need of a new mortgage loan. The listing data may include at least a listing address. Comparing the client data and the listing data involves matching a client address corresponding to a client name of the client data with a listing address of the listing data. The method further allows a user to repeat any of the steps to reflect updated data. The method may further comprise the step of notifying at least one third-party that a client of the client data may be in need of a new mortgage loan or related goods and services.

In an embodiment, a system for analyzing and forecasting the performance of a mortgage-backed security or pool thereof and identifying potential mortgage borrowers comprises a computer readable medium, an input means, a processor, and a display module. The computer readable medium stores the aforementioned valuation data, mortgage data, listing data, and client data within at least one database. The input means allows a user to manipulate the valuation data, the mortgage data, the listing data, the client data, and the at least one database. The processor executes various routines and commands for manipulating the valuation data, mortgage data, listing data, and client data. The display module may be any display device for displaying the valuation data, mortgage data, listing data, client data, at least one database, financial status, and performance rating.

In a further embodiment, the system executes a risk analyzer subroutine to run the method for analyzing and forecasting the performance of a mortgage-backed security or pool thereof on the system. In a further embodiment, the system executes a borrower identifier subroutine to run the method for identifying potential mortgage borrowers on the system. In still a further embodiment, the system executes a series of commands from the user for running all or part of at least one of the above methods.

These together with other aspects of the present disclosure, along with the various features of novelty that characterize the present disclosure, are pointed out with particularity in the claims annexed hereto and form a part of the present disclosure. For a better understanding of the present disclosure, its operating advantages, and the specific objects attained by its uses, reference should be made to the accompanying drawings and detailed description in which there are illustrated and described exemplary embodiments of the present disclosure.

### DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 shows an exemplary diagram of the sources from which data is retrieved and computer systems involved in the disclosed methods in accordance with an exemplary embodiment of the present disclosure;

FIG. 2 shows an exemplary flow chart illustrating the steps of the disclosed method for analyzing and forecasting the performance of a mortgage-backed security or pool thereof in accordance with an exemplary embodiment of the present disclosure;

FIG. 3 shows an exemplary flow chart illustrating the steps of the disclosed method for identifying potential mortgage borrowers in accordance with an exemplary embodiment of the present disclosure; and

FIG. 4 shows an exemplary computer system diagrammed hierarchically in table view in accordance with an exemplary embodiment of the present disclosure.

Like reference numerals refer to like parts throughout the description of several views of the drawings.

### DETAILED DESCRIPTION OF THE DISCLOSURE

The best mode for carrying out the present disclosure is presented in terms of its preferred embodiments, herein depicted in the accompanying figures. The preferred embodiments described herein detail for illustrative purposes are subject to many variations. It is understood that various omissions and substitutions of equivalents are contemplated as circumstances may suggest or render expedient, but are intended to cover the application or implementation without departing from the spirit or scope of the present disclosure.

The terms “a” and “an” herein do not denote a limitation of quantity, but rather denote the presence of at least one of the referenced items.

The present disclosure comprises a system and method for analyzing and forecasting the performance of a mortgage-backed security or pool thereof and identifying potential mortgage borrowers. In an embodiment, a method for analyzing and forecasting the performance of a mortgage-backed security or pool thereof allows a user to determine whether investing or maintaining and investment in a mortgage-backed security on a particular real property would likely result in a profit or a deficit. Such a determination is based on the comparison of actual data, such as mortgage data relating to at least one of the original loan amount, execution date, interest rate, and loan term for the real property, and valuation data relating to at least one of the listing price, fair market valuation, appraisal amount, and real estate comparison valuation for the real property. The data is retrieved from various existing and preferably public records and reflects accurate amounts, values, terms, and the like. The user utilizes the mortgage data to calculate an outstanding, current mortgage balance for the real property and the valuation data to determine a property value thereof. Comparing the data informs the user as to whether the property value for the real property is greater than or less than the current mortgage balance, which comparison indicates whether a sale of such real property at that property value will result in a profit or deficit for the corresponding security's investors. Thus, the method uses actual data to determine how a security over that real property is or will be performing.

In an embodiment, a method for identifying potential mortgage borrowers allows a user to determine whether the owner of a real property listed for sale may be in need of a new mortgage loan. Just as with the above method for analyzing and forecasting the performance of securities, this method similarly involves collecting actual data, such as the listing data including a listing address, and client data relating to a list comprising client names and corresponding addresses, which data is also collected from various records for accuracy. In an embodiment, the user compares the listing address prescribed in the listing data with the client addresses of the client data to determine whether a client named on the client list may be selling his or her real property. The results of this comparison may be used by third parties, such as financial lending institutions, to provide targeted marketing for mortgage loan offers to such clients. The results may further be used by other third parties to provide targeted marketing for related goods and services that may be desired or needed by someone buying and/or selling a real property.

In an embodiment, a system, such as a computer system, is capable of executing various routines and user commands to cause the aforementioned methods to be performed. The system may allow the user to retrieve all of the collected, actual data online by connecting to different servers, or it may receive such actual data directly from the user manually inputting or transferring it into the system's computer readable medium. The system may include at least one database within which all of the data may be organized and stored. The system allows the user to manipulate the data using an input means, which preferably may be a keyboard and mouse configuration, but may instead be of any configuration sufficient to review, edit, and otherwise use such data. The processor of the system causes all of the user commands to be executed and may as well execute one or more subroutines, which commands and subroutines may be directed to the performance of one or both of the methods for analyzing and forecasting the performance of a mortgage-backed security or pool thereof and identifying potential mortgage borrowers. The system includes a display module for providing the user with a visual representation of all of the data, the manipulations made via the input means, and the subroutines and user commands executed thereon.

It will be apparent that the disclosed methods may apply to either or both potential residential mortgage borrowers and potential commercial mortgage borrowers, and further that the term “real property” as herein and hereafter used may refer to either or both of a residential real property and a commercial real property. Accordingly, and as will be shown, the disclosed system and methods are designed to work with both residential mortgage-backed securities and commercial mortgage-backed securities.

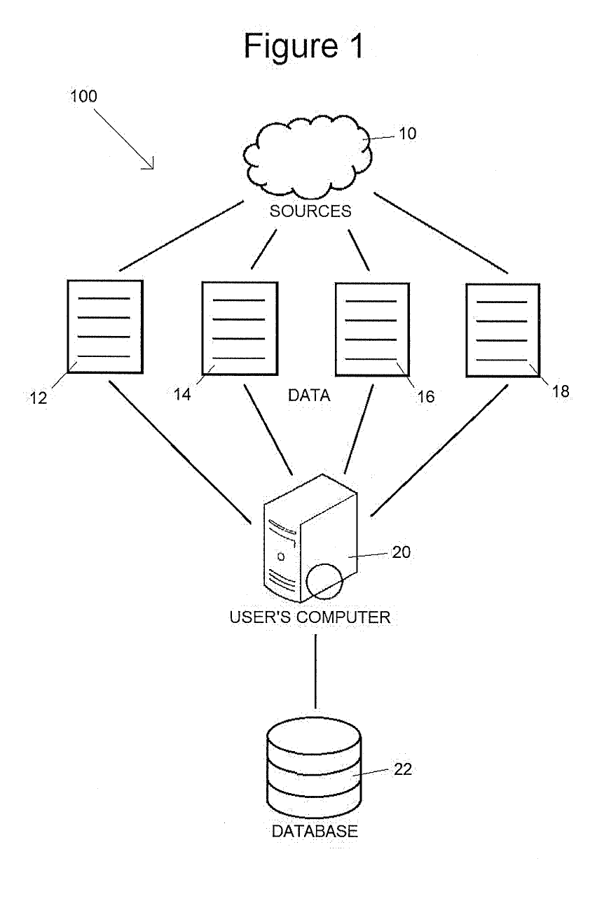

Referring now to FIG. 1, a diagram is shown at 100 as indicating connections between the disclosed system (hereinafter referred to as “the user's computer”) 20 and the various sources 10 from which the valuation data 12, mortgage data 14, listing data 16, and client data 18 are retrieved, which various sources 10 may be computer servers, written or printed materials, or oral conveyances. Preferably, the retrieved data will be embodied in some written, printed, or digital format at the time at which it is retrieved; however, it will be apparent that data received orally, such as that via telephonic or in person conversation, will be sufficient as long as it is accurate. In an embodiment where the data is retrieved from one or more servers, the user would log onto the server containing the records such as a website, which website, for example, may be a county clerk's office website or real estate listing website, and search for and thereafter download the desired data onto the computer readable medium of the user's computer 20. In an embodiment where the data is retrieved from a written or printed material, the written or printed material may be scanned or manually entered into computer readable medium of the user's computer 20. In an embodiment where the data is retrieved by oral conveyance, the data may be manually entered into the computer readable medium of the user's computer 20.

The disclosed methods (described in detail below) require accurate or reliable data as input. Specifically, the methods require the retrieval of valuation data 12, mortgage data 14, listing data 16, and client data 18. The valuation data 12 is any data that conveys the value of the real property in question. In an embodiment, the valuation data 12 may comprise at least one of a listing price (such as that from a real estate sales listing), a fair market valuation (such as that conducted by a marketing or similar agency or firm), an appraisal amount (such as that which is determined by a real property appraiser), and a real estate comparison valuation (such as that from a real estate agency). The mortgage data 14 provides important information relating to a mortgage loan transaction for the real property in question. In an embodiment, the mortgage data 14 may comprise at least one of an original loan amount (such as the total amount of the loan as executed), a purchase amount (such as the total price paid for the real property), an execution date (such as the date the mortgage was entered into), an interest rate (which rate may be static or dynamic depending on the specific terms of the mortgage loan transaction), and a loan term (which may, for example, be fifteen or thirty years in length). The client data 18 indicates the name and/or address for at least one customer or client of a business. In an embodiment, the client data may comprise a list of customer's names and addresses, which customers have at least once patronized the business from which the list derived. The listing data 16 contains a plurality of real estate sales listings, and, specifically, conveys the addresses corresponding to such real estate sales listings. In an embodiment, the listing data 16 may comprise one or more addresses, which may pertain to residential or commercial properties, and may further comprise the legal description and/or commonly known as name for the real property.

In order for the disclosed methods to be performed properly, the retrieved data must be accurate or reliable. Thus, the various sources 10 from which such data is retrieved must be official or sufficiently trustworthy. For example, and preferably, where the real property in question is listed for sale, the valuation data 12 may derive from the real estate agency listing the property for sale or from a similar agency; however, the valuation data 12 may similarly derive from a marketing or appraisal agency. Also by example, and also preferably, the mortgage data 14 may derive from the county clerk's office of the county in which the at least one real property in question is located. County clerk's offices are government offices that record all data relating to mortgage loan transactions on real properties and maintain those records completely. It will be apparent that the term “county clerk's office” may additionally refer to a register of deeds or similar governmental department used to maintain real property records. If necessary, the mortgage data 14 may alternatively derive from the records of the financial lending institution that entered into the mortgage loan transaction in question. Also by example, and also preferably, the listing data 16 may derive from the real estate agency retained to sell the real property in question. However, the listing data 16 may similarly be obtained from any of the plurality of third-party entities that are in the business of advertising, marketing, or otherwise displaying real property listings to the general public. The client data 18 may derive from any business or other entity, which may be a financial lending institution or other entity related in any capacity to real property (which capacity, as will be discussed below, may be defined broadly to include service providers such as cable and Internet entities, moving entities, home improvement entities, and so forth). It will be apparent that, as stated above, the valuation data 12, mortgage data 14, client data 18, and listing data 16 may be derived from any source 10, be it public or private, so long as the data retrieved therefrom is accurate or reliable.

Once the valuation data 12, mortgage data 14, listing data 16, and client data 18 are retrieved and stored on the computer readable medium of the user's computer 20, the user may organize the data thereon as desired. For example, the user may choose to store all such data within one or more databases 22 for convenience. It will be apparent that the term “database” as used herein may refer to any digital file for retaining at least some of the data, which digital file may be one of a database, repository, spreadsheet, electronic document, or other suitable format. In a preferred embodiment, the valuation data 12, mortgage data 14, listing data 16, and client data 18 are all stored within a single database 22. In another embodiment, the various data are stored in multiple databases 22 within the computer readable medium of the user's computer 20.

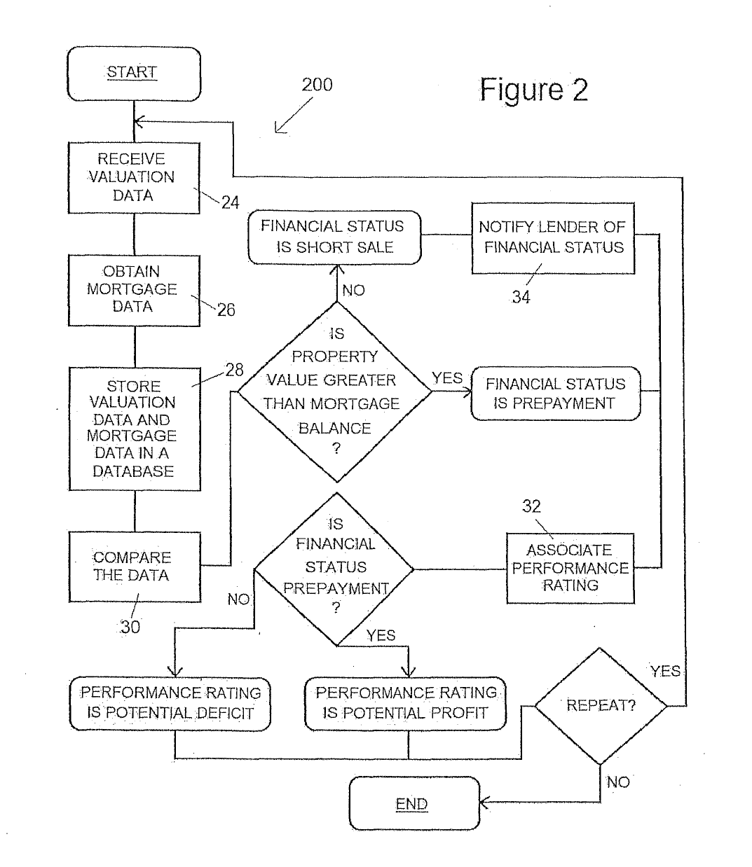

The flow chart of FIG. 2 depicts the steps of the method 200 for analyzing and forecasting the performance of a mortgage-backed security or pool thereof. As is shown, the first step is the receiving step 24, which requires the user to receive the valuation data for the at least one real property from some source, and the second step is the obtaining step 26, which similarly requires the user to obtain the mortgage data for the at least one real property from some source. Also, the third step of the method 200 is the storing step 28 wherein the user stores the mortgage data and valuation data for the at least one real property in at least one database within the computer readable medium of the user's computer.

As discussed above, the receiving step 24 and obtaining step 26 may involve the user retrieving digital, written, printed, or oral versions of the data, and the storing step 28 may involve the user transferring or manually entering that data within the at least one database. The receiving step 24, obtaining step 26, and storing step 28 conjunctively comprise the portion of the disclosed method wherein the user collects the data to be used therewith. Once the data has been retrieved and is stored on the user's computer, the user may proceed with the method to begin the steps involved in determining the performance of the at least one real property that is/are the subject(s) of the analysis.

Accordingly, the fourth step of the disclosed method is the comparing step 30, which requires the user to compare the mortgage data and the valuation data to determine a financial status for the at least one real property. Specifically, and to begin the comparing step 30, the user must extrapolate a mortgage balance that indicates the current outstanding amount owed on the mortgage in question. The mortgage balance is what will be compared against the property value of the at least one real property to determine the overall performance of the security thereon. Calculating the mortgage balance requires the user to take multiple other values into consideration, which include, but may not be limited to, the original loan amount that was agreed to when the mortgage loan transaction was executed, the interest rate applied to the mortgage loan transaction, the term of the mortgage (e.g. fifteen or thirty years), the execution date of the mortgage loan transaction, and the current date (i.e. the date on which the calculation is being done). Using this information, the user may determine an accurate or reliable figure representing the remaining balance on the mortgage.

In an embodiment, the user preferably completes two different calculations in particular during the comparing step 30—that is, in order to determine a financial status for the at least one real property, the user may first calculate the monthly mortgage payment (i.e. the amount paid by the borrower during each month of the mortgage loan term) and may thereafter calculate the total amount owed on the mortgage as of the current date (i.e. the mortgage balance) using that monthly mortgage payment value. To calculate the monthly mortgage payment, the user may need to know at least the original loan amount, the interest rate, the loan term, the execution date, and the current date, all of which may have derived from the mortgage data (except for the current date). Since we are expressing these calculations in months, the user may divide the annual interest rate of the loan by twelve to determine the monthly interest rate, which we will call R. For example, for an interest rate of five percent, the monthly interest rate, R, would be 0.004167, or the quotient of 0.05 divided by 12. Thus, using R, we can express the monthly mortgage payment using the following formula:

P=A/((1−(1/(1+R)̂L))/R)

Where P is the monthly mortgage payment, A is the original loan amount, and L is the loan term. For example, say that the original loan amount for the mortgage, A, is $200,000.00 and that the loan term, L, is thirty years, or 360 months. Using our exemplary interest rate value calculated above, we can calculate our monthly mortgage payment, P, which equals $1,073.69. It will be apparent that this calculation does not factor in additional monthly fees and expenses, such as insurance, tax, and other proportioned inclusions. Next, using the loan term, execution date, and current date, the user may calculate the remaining loan term, also expressed in months. To do this, the user may find the difference between the execution date and the current date and may thereafter subtract that numeric value from the loan term. Written out as an expression, this formula is:

N=L−D

Where N is the total remaining loan term and D is the difference between the execution date and the current date, both expressed in terms of months. For example, say we use the above value of 360 months for the loan term, and further that the execution date is Jul. 1, 2003, and the current date is Jul. 1, 2013. The difference between the execution date and the current date is ten years, which is 120 months. So, the total remaining loan term, N, is 240 months, or the difference between 360 and 120. Now that the user has calculated the monthly mortgage payment, P, and the remaining loan term, N, he or she may move on to calculate the total outstanding mortgage balance as of the current date. To do so, the user may make the calculations expressed by the following formula:

B=(P/R)*(1−(1/(1+R)̂N))

Where B is the total outstanding mortgage balance as of the current date. Thus, continuing with the exemplary numbers as used in the above paragraphs, the mortgage balance, B, as of Jul. 1, 2013, would equal $162,689.67, or the product of $257,664.98 and 0.6314. It will be apparent that although the above calculations are discussed as having implicated one month as the standard increment, any period of time may be sufficient for the calculations herein discussed. However, should a user decide to use a period of time other than that which is used herein, he or she may need to adjust the formulas to account for this change, as the formulas as they are prescribed herein denote the calculations using months as the increments of choice. It will be further apparent that although the above calculations prescribe one embodiment for calculating the mortgage balance, there may be numerous embodiments that may be utilized for sufficiently calculating the mortgage balance.

Once the user has finished calculating the mortgage balance, he or she must next isolate the property value for the real property in question from the valuation data. The property value may be indicated by the values conveyed by any of a listing price (where the real property is listed for sale), a fair market valuation, an appraisal amount, and a real estate comparison valuation. In an embodiment, the user may elect to average two or more of these values to isolate the property value. Further, it will be apparent that, where the real property in question is listed for sale, while the property value may not reflect the actual purchase price of the real property once a sale therefore has been completed, it will provide an adequate basis for understanding the financial status of the property.

As such, after the user has retrieved the property value for the real property from the valuation data, he or she may then compare it to the mortgage balance previously calculated. This comparison is what yields the financial status for the real property, which financial status itself indicates the performance of a mortgage-backed security for the real property in question. The financial status may comprise one of a prepayment and a short sale wherein “prepayment” indicates that a sale of the real property will at least fully satisfy the existing mortgage balance, and wherein “short sale” indicates that a sale of the real property will not fully satisfy the mortgage balance. Thus, if the user determines that the property value for the real property is greater than the calculated mortgage balance, the financial status thereof is a prepayment, and if the user determines that the property value for the real property is less than the calculated mortgage balance, the financial status thereof is a short sale. For example, using the exemplary balance calculated above, if the property value for the real property is $180,000.00, the financial status would be a prepayment.

The user may proceed to the fifth and final step of the method, the associating step 32, after the financial status for the at least one real property has been determined. The associating step 32 involves associating a performance rating with the at least one real property based on the financial status thereof. The performance rating is the overall understanding of the investment potential of the real property in question and is what is used to communicate the potential investment value thereof to current and potential investors. The performance rating may indicate either that investing or maintaining an investment in the real property in question may result in a profit or may instead result in a deficit. Thus, where the financial status is determined to be a prepayment, the performance rating may indicate that investing or maintaining an investment in the real property will result in a financial gain, and where the financial status is determined to be a short sale, the performance rating may instead indicate that investing or maintaining an investment therein will result in a financial loss. As such, the example as discussed herein would receive a performance rating indicating a potential profit.

It will be apparent that the particular embodiment of the performance rating may be any configuration that adequately conveys the positive or negative rating for the real property. For example, in an embodiment, the performance rating may be an illustration of either a “thumbs up” or a “thumbs down,” or it may be an illustration of either a “smiling face” or a “frowning face.” In another embodiment, the performance rating may be a simple text prescribing the terms “good” and “bad,” or synonyms thereof. Nevertheless, it is clear that any embodiment of representing positive versus negative ratings may be used herewith to sufficiently portray the associated performance rating.

In an embodiment, the method 200 may further comprise a notifying step 34 wherein the user may inform a lender that a real property it holds a mortgage on is being or may be listed for sale at a price that is lower than the outstanding mortgage balance. Thus, where the financial status for a real property comprises a short sale, the user may notify the corresponding lender of such status. The lender may then use this information to enter into a new or revise an existing payment plan with the borrower, thereby avoiding the occurrence of a short sale, which occurrence may result in the lender, and any investors, losing money.

Further, the method 200 provides for the repetition of certain steps thereof upon the user determining that some or all of the data has been updated. For example, where the user learns that some of at least one of the mortgage data and the valuation data has changed, he or she may repeat the receiving step 24, the obtaining step 26, and the storing step 28 to reflect those changes. The user may then respectively repeat the comparing step 30 and the associating step 32, and, as necessary, the notifying step 34, in order to establish and convey the updated performance rating to be associated with the at least one real property.

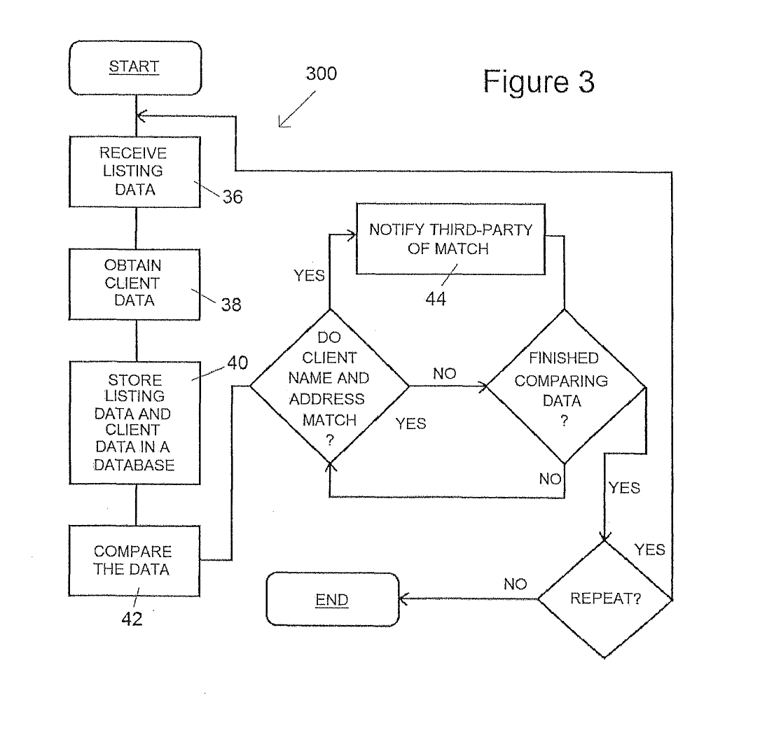

The flow chart of FIG. 3 depicts the steps of the method 300 for identifying potential mortgage borrowers. As is shown, and similar to the method depicted in the previous figure, the first step is the receiving step 36, which requires the user to receive the listing data for the at least one real property from some source, and the second step is the obtaining step 38, which requires the user to obtain the client data comprising a list of client names and corresponding addresses. Also, the third step of the method 300 is the storing step 40 wherein the user stores the mortgage data and listing data for the at least one real property in at least one database within the computer readable medium of the user's computer.

As with the previous method, the receiving step 36 and obtaining step 38 of this method 300 may involve the user retrieving digital, written, printed, or oral versions of the data, and the storing step 40 may involve the user transferring or manually entering that data within the at least one database. The receiving step 36, obtaining step 38, and storing step 40 conjunctively comprise the portion of the disclosed method wherein the user collects the data to be used therewith. Once the data has been retrieved and is stored on the user's computer, the user may proceed with the method to begin the steps involved in determining whether any clients prescribed within the client data may be in need of a new mortgage loan or may otherwise be purchasing or financing a new real property.

Accordingly, and similar to that which is discussed above, the fourth step of this method 300 is the comparing step 42, which requires the user to compare the client data and the listing data to determine whether a client listed in the client data may be putting his or her real property for sale on the market, which may infer that such client may be in need of a new mortgage loan. This determination requires the user to compare the client data against the listing data. Specifically, the user may peruse the listing data for any listing addresses that appear in the client data as well. Should the user find any listing addresses of the listing data that match a client address of the client data, the user may then isolate the client name corresponding to such client address, which client name will represent a client that may be in need of a new mortgage loan. It will be apparent that the term client as used herein may refer to an individual, a group of individuals, an entity, a group of entities, a trust or similar estate mechanism, or any combination thereof.

Once the user has determined that a particular client of the client data may be in need of a new mortgage loan, the user may utilize such information to notify at least one third-party of such potential need during the notifying step 44. Notifying the at least one third-party in this regard requires the dissemination of at least one of the client's name and the client's address, and, in a preferred embodiment, involves the dissemination of both. The third-party being notified of such client need may be a financial lending institution such as an entity capable of entering into a new mortgage loan transaction with such client. Additionally, the third-party being notified may be one that is otherwise directly or indirectly related to the real property or mortgage industries, such as a service provider. For example, the method 300 may notify a third-party including, but not limited to, a professional moving company, a cable/Internet provider, and a construction or carpentry company that the client may be in need of a new mortgage loan and thus may be moving. Notifying these companies of the client's need for a new mortgage loan may result in those companies and providers providing targeted marketing to that client, and may in turn bring in additional business for those companies and providers.

As with the previous method, this method 300 allows the user to repeat certain steps thereof upon determining that at least one of the client data and the listing data has been updated since the method was completed. Thus, where some or all of the data has been updated, the user may repeat the receiving step 36, the obtaining step 38, and the storing step 40 to reflect those changes. The user may then respectively repeat the comparing step 42 and the notifying step 44 in order to establish the updated matching of clients' addresses to listing addresses, which updated matching updates the user as to which clients of the client data may be in need of a new mortgage loan or may otherwise be purchasing or financing a new real property.

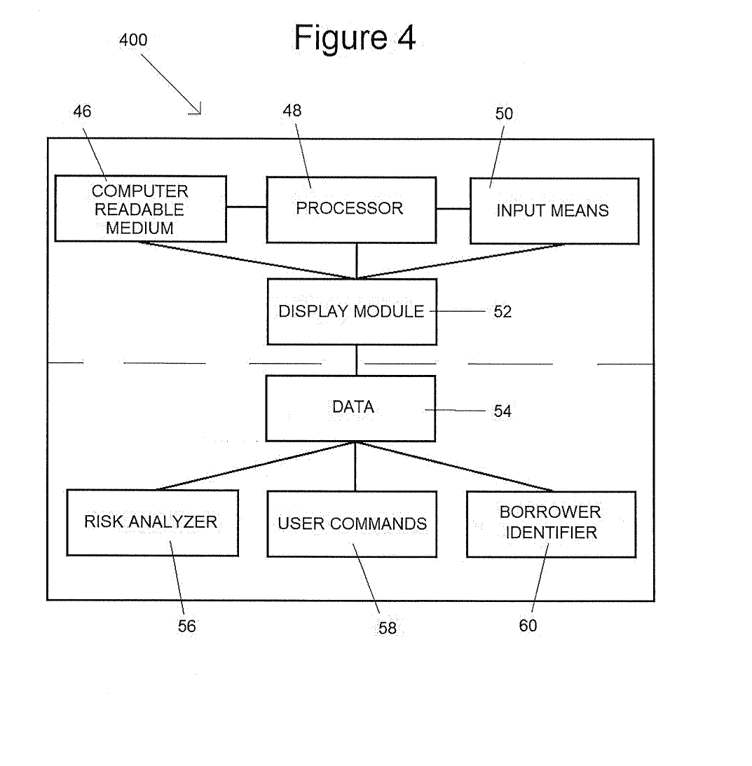

A system capable of running the disclosed methods is diagrammed in FIG. 4, which diagram illustrates the various components of such system 400 and indicates their relation to one another. The system 400 is a computer system and therefore comprises a computer readable medium 46, an input means 50, a processor 48, and a display module 52. The computer readable medium 46 may be a random access memory, or RAM, capable of loading various programs and other routines to be executed by the processor 48 for use by the user. The computer readable medium 46 may also be a read-only memory, or ROM, such as a hard drive, capable of storing the valuation data 54, mortgage data 54, listing data 54, and client data 54 within at least one database. In a preferred embodiment, the computer readable medium comprises a RAM and a ROM. The input means 50 comprises a means for allowing the user to interact with and otherwise manipulate the various software environments on the system 400, as well as the aforementioned data and the at least one database within which such data 54 is stored. In a preferred embodiment, the input means 50 is a keyboard and mouse configuration that is operatively coupled to the system 400 via wired or wireless connections. In a further embodiment, the input means 50 may be touch-based, such as a touch-screen, which allows the user to manipulate data 54 using his or her fingers and thus without the need of additional accessories.

The processor 48 is capable of executing commands and other programs and routines, and performs any calculations that are necessary to communicate any information that may need to be transmitted between it and the other components of the system 400. In an embodiment, the processor 48 executes pre-programmed subroutines, which subroutines may comprise executable application files. In another embodiment, the processor 48 executes user commands for executing various actions. In a preferred embodiment, the processor 48 is capable of executing both subroutines 56 and 60 and user commands 58. The display module 52 may be any screen for viewing the user interfaces embodied by the programs, routines, and commands being executed by the processor 48. In an embodiment, the display module 52 may be a computer monitor, television, projector, or other viewing device.

In an embodiment, the system 400 runs the disclosed methods by executing subroutines, wherein one subroutine pertains to each disclosed method. For example, when the user seeks to begin the disclosed method for analyzing and forecasting the performance of a mortgage-backed security or pool thereof, the processor 48 may execute a risk analyzer subroutine 56 that collects the valuation data 54 and mortgage data 54 and compares them as disclosed above to associate a performance rating with at least one real property. The risk analyzer subroutine 56 is further capable of updating the valuation data 54 and mortgage data 54 and thereafter repeating the comparing and associating steps of such method to update the performance rating as necessary. Similarly, and also for example, when the user seeks to begin the disclosed method for identifying potential mortgage borrowers, the processor 48 may execute a borrower identifier subroutine 60 that collects the client data 54 and listing data 54 and compares them as disclosed above to determine whether any clients of the client data 54 may be in need of a new mortgage loan. The borrower identifier subroutine 60 may further notify at least one third-party of that client's or those clients' need(s), and the borrower identifier subroutine 60 is further capable of updating the client data 54 and listing data 54 and thereafter repeating the comparing and notifying steps of such method as necessary.

In a further embodiment, the system 400 runs the disclosed methods by executing a series of user commands 58 for performing the various steps thereof. For example, the processor 48 may cause a spreadsheet program to open upon such command from the user, which spreadsheet program may receive the various valuation data, mortgage data, listing data, and/or client data therein, and the processor 48 may thereafter cause a separate program to open upon a further command from the user, which separate program may allow for another or the remainder of the steps of the disclosed methods to be run thereby. It will be apparent that this embodiment supports the processor 48 executing as many user commands as may be necessary in order to complete either or both of the disclosed methods, which user commands may relate to the opening of a file or software application, the saving of various data, the connection to one or more servers for retrieving data, and any other action capable of being performed by a computer.

The system and method disclosed herein provide various advantages over the prior art. By using actual data to calculate the outstanding mortgage balance and determine a financial status therefrom, the disclosed system and method provide an accurate performance rating indicating the potential profit or deficit associated with investing or maintaining and investment in a mortgage-backed security for a particular real property. The utilization of actual data obviates projections and approximations, which may yield inaccurate results and may cause an investor to wrongly invest or maintain an investment in a poorly performing security. Further, by using actual client data to determine whether any clients are in need of a new mortgage loan or may otherwise be purchasing or financing a new real property, the disclosed system and method provide for increasingly-accurate targeted marketing of goods and services, which directs such clients to the businesses they need and directs those businesses to new customers.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the disclosure and various embodiments with various modifications as are suited to the particular use contemplated.

What is claimed is:

1. A method for analyzing and forecasting the performance of a mortgage-backed security or pool thereof, the method comprising the steps of:
receiving valuation data for at least one real property, the valuation data including at least one of a listing price, a fair market valuation, an appraisal amount, and a real estate comparison valuation;
obtaining mortgage data for the at least one real property, the mortgage data including at least one of an original loan amount, a purchase amount, an execution date, an interest rate, and a loan term;
storing the mortgage data and the valuation data in at least one database;
comparing the mortgage data and the valuation data to determine a financial status for the at least one real property, wherein comparing the mortgage data and the valuation data comprises the steps of:
extrapolating a mortgage balance using the mortgage data and a current date for each at least one real property;
retrieving a property value based on the valuation data for each at least one real property; and
determining whether the property value is greater than or less than the mortgage balance for each at least one real property; and
associating a performance rating with the at least one real property based on the financial status of the at least one real property,
wherein a user may thereafter repeat at least one of said receiving step and said obtaining step in order to update the valuation data and the mortgage data respectively at any time by retrieving updated valuation data and mortgage data, and wherein the user may thereafter repeat said storing step in order to update at least one of the mortgage data and the valuation data stored in the at least one database, and
wherein the user may thereafter repeat said comparing step in order to update the financial status for the at least one real property using the updated mortgage data and valuation data, and wherein the user may thereafter repeat said associating step in order to update the performance rating for the at least one real property.

2. The method as claimed in claim 1, wherein the financial status of said comparing step comprises one of a short sale and a prepayment, the financial status being a short sale wherein the property value of said comparing step is less than the mortgage balance of said comparing step, the financial status being a prepayment wherein the property value of said comparing step is greater than the mortgage balance of said comparing step.

3. The method as claimed in claim 2, wherein the performance rating of said associating step indicates one of a potential profit and a potential deficit associated with investing in a security for the at least one real property or maintaining an investment in a security for the at least one real property, the performance rating indicating a potential profit wherein the financial status comprises a prepayment, the performance rating indicating a potential deficit wherein the financial status comprises a short sale.

4. The method as claimed in claim 2, wherein the method further comprises the step of notifying a lender of a mortgage on the at least one real property where the financial status for the at least one real property is a short sale.

5. A computer-implemented method for identifying potential mortgage borrowers, the method comprising the steps of:
receiving on a non-transitory computer readable medium listing data for at least one real property, the listing data including at least one listing address;
obtaining on the non-transitory computer readable medium client data, the client data including at least one of at least one client name and at least one client address;
storing the client data and the listing data in at least one database on the non-transitory computer readable medium; and
comparing the client data and the listing data to determine whether a client of the client data may be in need of a new mortgage loan or may otherwise be purchasing or financing a new real property, wherein comparing the client data and the listing data comprises the steps of:
retrieving a listing address based on the listing data for each at least one real property; and
matching a client address corresponding to a client name with the listing address,
wherein a user may thereafter repeat at least one of said receiving step and said obtaining step in order to update the listing data and the client data respectively at any time by retrieving updated listing data and client data, and wherein the user may thereafter repeat said storing step in order to update at least one of the client data and the listing data stored in the at least one database, and
wherein the user may thereafter repeat said comparing step in order to determine whether a client address corresponding to a client name of the client data matches any of the updated listing data or whether a listing address matches any of the updated client data, and
wherein the method, when performed on a computer, is capable of comparing the client data and the listing data in order to instantaneously identify a plurality of potential mortgage borrowers, and wherein the method must be performed on a computer in order to effectuate the instantaneous identification of the plurality of potential mortgage borrowers, and
wherein prior to the performance of the method it is unknown whether a client of the client data is in need of a new mortgage loan, and wherein performing the method results in a list of identified potential mortgage borrowers, which list is stored on the non-transitory computer readable medium.

6. The method as claimed in claim 5, wherein the method further comprises the step of notifying at least one third-party that a client name of the client data matched with a listing address of the listing data may be in need of a new mortgage loan or may otherwise be purchasing or financing a new real property.

7. The method as claimed in claim 6, wherein said notifying step further comprises notifying at least one third-party that a client name of the client data matched with a listing address of the listing data may be in need of a good or service associated with purchasing or financing a new real property.

8. A system for identifying potential mortgage borrowers, the system comprising:
a computer readable medium, said computer readable medium capable of storing listing data and client data within at least one database;
an input means, said input means capable of allowing a user to manipulate said listing data, said client data, and said at least one database;
a processor, said processor capable of recognizing said input means, said processor capable of comparing said client data and said listing data to determine whether a client name of said client data may be in need of a new mortgage loan or may otherwise be purchasing or financing a new real property, said processor capable of executing instructions for performing a method for identifying potential mortgage borrowers; and
a display module, said display module capable of displaying said listing data, said client data, and said at least one database,
wherein the method for identifying potential mortgage borrowers, when performed on the system, is capable of comparing the client data and the listing data in order to instantaneously identify a plurality of potential mortgage borrowers.

9. The system as claimed in claim 8, wherein said processor executes a risk analyzer, said risk analyzer collecting said mortgage data and said valuation data for at least one real property, said risk analyzer storing said mortgage data and said valuation data within said at least one database, said risk analyzer comparing said mortgage data and said valuation data to determine said financial status for the at least one real property, said risk analyzer associating said performance rating with the at least one real property based on said financial status, said risk analyzer updating said performance rating for the at least one real property upon collecting at least one of updated said mortgage data and updated said valuation data.

10. The system as claimed in claim 9, wherein comparing said mortgage data and said valuation data comprises extrapolating a mortgage balance using said mortgage data and a current date for each at least one real property, retrieving a property value based on said valuation data for each at least one real property, and determining whether said property value is greater than or less than said mortgage balance for each at least one real property.

11. The system as claimed in claim 9, wherein said risk analyzer notifies a lender of a mortgage on the at least one real property where said financial status for the at least one real property is a short sale.

12. The system as claimed in claim 8, wherein said instructions for performing a method for identifying potential mortgage borrowers comprises a borrower identifier, said borrower identifier collecting said listing data and said client data, said borrower identifier storing said listing data and said client data within said at least one database, said borrower identifier matching a client address of said client data with a listing address of said listing data in order to determine whether a client name corresponding to said client address may be in need of a new mortgage loan or may otherwise be purchasing or financing a new real property, said borrower identifier capable of repeating upon collecting at least one of updated said listing data and updated said client data.

13. The system as claimed in claim 12, wherein said borrower identifier notifies at least one third-party that said client name may be in need of a new mortgage loan or may otherwise be purchasing or financing a new real property, and wherein said borrower identifier notifies at least one third-party that said client name may be in need of a good or service associated with purchasing or financing a new real property.

14. The system as claimed in claim 8, wherein said processor executes at least one user command, said at least one user command relating to at least a part of a method for identifying potential mortgage borrowers.

15. The system as claimed in claim 8, wherein said valuation data includes at least one of a listing price, a fair market valuation, an appraisal amount, and a real estate comparison valuation.

16. The system as claimed in claim 8, wherein said mortgage data includes at least one of an original loan amount, an execution date, an interest rate, and a loan term.

17. The system as claimed in claim 8, wherein said listing data includes at least one listing address.

18. The system as claimed in claim 8, wherein said client data includes at least one of at least one client name and at least one client address.
